(19) United States
(12) Patent Application Publication
(10) Pub. No.: US 2018/0352815 A1
(43) Pub. Date: Dec. 13, 2018

(54) Multi-Application Insect Repellent Additive

(71) Applicant: Cypress Bio-Tech Company Limited, Kowloon (CN)

(72) Inventors: Stanley Bak Hang Poon, Kowloon (CN); Michael Tsang Ming Choi, Kowloon (CN)

(21) Appl. No.: 16/004,570

(22) Filed: Jun. 11, 2018

Related U.S. Application Data
(60) Provisional application No. 62/518,111, filed on Jun. 12, 2017.

(51) Int. Cl. A01N 53/00; A01N 25/08; A01N 25/26; A01N 43/80; D06F 41/00

(52) U.S. Cl. CPC A01N 53/00; A01N 25/08; D06F 41/00; A01N 43/80; A01N 25/26

(57) ABSTRACT

A method of adding a multi-application insect repellent additive (hereafter, “the additive”) includes the steps of: providing the additive, immersing a textile in a fluid medium including the additive within a laundry-cleaning apparatus, disseminating the additive throughout the fluid medium and the textile, partially removing the fluid medium from the textile and drying the textile. After completing these steps, the additive is retained by the textile. In the disclosed embodiment, the additive may be formed of permethrin, encapsulated natural extracts, and or other disclosed formulations.

### BACKGROUND

The present disclosure relates to methods and formulations for repelling and/or killing insects. More specifically, the disclosure relates to insect repellent additive compositions that may be administered topically and/or applied to a textile worn by a user.

The application of residual insecticides to textiles for repelling and/or killing insects as a form of personal protection against vector-borne diseases is known in the art. Pyrethoids, such as permethrin, are used for this purpose due to their high insecticidal activity combined with low mammalian toxicity, making them ideal for treating textiles worn by humans.

Unfortunately, due to fast biodegradation and currently employed methods for treating textiles with insecticides, attempts to maintain an effective level of active ingredient in the textile to repel and/or kill insects, especially after multiple washings of the textile, have not been entirely successful. Further, the currently available methods for applying insecticides to textiles are expensive, which make their manufacture and/or use impractical, especially in areas of limited economic resources.

There is a need for a multi-application insect repellent additive that may be administered topically, applied to a textile worn by a user, is easily incorporated into a textile, is not easily washed off and can maintain effectiveness, even after repeated washing of a treated textile.

### SUMMARY OF THE INVENTION

Briefly stated, a multi-application insect repellent additive (hereinafter “the additive”) is disclosed. In the disclosed embodiments, the additive is administered topically and/or to a textile worn by a user to repel and/or kill insects. The additive may be applied as a lotion, cream, spray or in a solution but other methods may be compatible with the disclosed embodiment. In one disclosed embodiment, the textile is a garment worn by the user but those skilled in the art will recognize that the textile may come in other forms such as blankets, towels, netting, rugs, etc. The disclosed additive includes multiple formulations, preparation methods and applications directed at enhancing insect repellence without subjecting the user to increased toxicity.

In one embodiment, a method of adding insect repellent to a textile is disclosed. The method most fundamentally comprises the steps of:
Step 1: Providing an insect repelling additive;
Step 2: Immersing a textile in a fluid medium including the insect repelling additive;
Step 3: Disseminating the insect repelling additive throughout the fluid medium;
Step 4: Partially removing the fluid medium from the textile, and
Step 5: Drying the textile.

After completing steps 1-5 of the method of the first embodiment, the additive is retained by the textile. In the disclosed embodiment, the additive may be formed of 0.10-5.00 fluid ounces of 0.10-5.00% permethrin, transfluthrin or related pyrethroid and/or encapsulated natural extracts. The additive may also include a portion of fabric softener.

It is contemplated that the method of the first embodiment is carried out during a rinse cycle in a laundry-cleaning apparatus.

It is also contemplated that the method of the first embodiment may be formulated for topical use.

### BRIEF DESCRIPTION OF THE DRAWINGS

Aspects of a preferred embodiment will be described in reference to the drawings:

FIG. 1 shows a flow chart of a method for incorporating a multi-application insect repellent additive into a textile.

### DETAILED DESCRIPTION

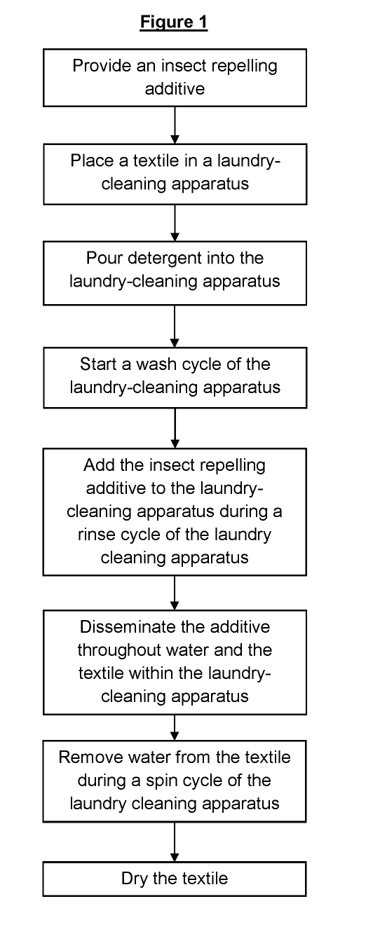

An embodiment of a multi-application insect repellent additive (hereafter “the additive”) according to aspects of the disclosure will now be described with reference to FIG. 1. Various ingredients and/or substances, methods of preparation, methods of formulation, and methods of application will be discussed in the context of the disclosed embodiment. It should be appreciated that where specific amounts and/or quantity of ingredients, temperatures or time measurements are expressed, the specific amounts and/or quantity of ingredients, temperatures or time measurements may be in the range of +/−10% from the specific quantity, unless a range is otherwise specified. Those skilled in the art will recognize known substitutes for the substances, preparation methods, formulation methods, and application methods, all of which are contemplated as compatible with the disclosed embodiment and are intended to be encompassed by the appended claims.

One object of the disclosed additive is to advantageously maintain an effective level of active ingredients to repel and/or kill insects. The disclosed additive incorporates ingredients and techniques, such as nanoencapsulation of permethrin, that are used to lengthen the effectiveness of the additive after it has been applied to a garment. The additive disclosed in all embodiments herein may be used to treat garments and/or be administered topically as a lotion, cream or spray.

With reference to one embodiment, the additive is used during a rinse cycle of a laundry-cleaning apparatus. For the purposes of this application, a laundry-cleaning apparatus is a laundry and/or washing machine and the rinse cycle is a period where detergent is removed from the laundry after a washing cycle. The additive is comprised of a permethrin solution within the range of 0.10% to 5.00% concentration but the preferred concentration in the disclosed embodiment is 1.00% permethrin. The additive may also be comprised of encapsulated natural extracts. The active ingredient of encapsulated natural ingredient include lemon eucalyptus, thyme, geranium, lavender, catnip, citronella, cedar wood, basil, tea tree, lemongrass, orange, pine, juniper, oregano, etc. The shell wall material includes PU polymer, polystyrene, chitosan, cellulosic resin, cyclodextrin, etc. In the disclosed embodiment, the amount of 1.00% permethrin or encapsulated natural extracts is in a range between 0.10 fluid ounces and 5.00 fluid ounces with a preferred amount of 2.70 fluid ounces.

To apply the additive to the garment of a user, the garment is first inserted into the laundry machine for washing. Detergent is added to the laundry machine to clean the garment during the washing cycle. The additive is added to the laundry machine for use during the rinse cycle. The additive is added to a fluid medium, preferably water, within the laundry machine during the rinse cycle. The additive and/or the fluid medium may also include a fabric softener. The additive is disseminated throughout the fluid medium and the garment within the laundry machine. After the rinse cycle, the fluid medium is partially removed from the garment, while the additive is retained by the garment. The garment is then dried while retaining the additive.

In a second embodiment, a method of formulating an encapsulated insect repellent nanoparticle additive comprises adding 0.05 grams of benzisothiazolinone to 45.00 grams of polyethylene glycol (PEG) 200 along with vigorous stirring until the benzisothiazolinone is substantially dissolved in the mixture. 20.00 grams of PEG400 and 5.00 grams of PEG600 are added along with stirring. 20.00 grams of permethrin are then added with continuous stirring, followed by 10.00 grams of TO5 or Tridecth-5, which is a polyethylene glycol ethers of tridecyl alcohol, along with stirring for approximately 30.00 minutes and/or until the mixture is homogenous.

It should be appreciated that the foregoing second embodiment and those disclosed hereafter are expressed in terms of a specific unit of mass, volume, length, temperature and time. It should be appreciated that the foregoing second embodiment and those expressed hereafter are intended to show proportions by mass, volume, length, temperature and time that can be expressed in any relative unit. Further, the second embodiment, and embodiments disclosed hereafter, may be added to a textile in a laundry machine in the same fashion as the first embodiment. The second embodiment, and embodiments disclosed hereafter, may also be combined with the first embodiment and/or with each other.

In a third embodiment, a method of formulating an encapsulated insect repellent nanoparticle additive comprises adding 82.00 grams of fatty acid amide derivative to 818.00 grams of deionized water along with vigorous stirring until the fatty acid amide derivative is substantially dissolved in the mixture. The additive is then added to the mixture of the second embodiment and stirred until the mixture is homogenous.

In a fourth embodiment, a method of formulating an encapsulated insect repellent nanoparticle additive comprises mixing 97.00 milliliters of deionized water with 1.00 milliliter of acetic acid and 0.50 grams of chitosan. The mixture is then filtered to eliminate insoluble impurities. The filtered mixture is heated to 80.00° C. in a flask equipped with a condenser. The mixture is purged with N₂ along with stirring for approximately 30.00 minutes. A mixture of 2.00 milliliters of vinyl acetate and 1.00 gram of 1.00% permethrin is added to the mixture. A 2.00 milliliter solution comprising 0.015 grams of potassium persulfate is added to the mixture. The reaction is kept at 70.00° C. for at least 6.00 hours. The resulting particle size of the reaction is between 300.00 nanometers to 900.00 nanometers. 8.85 grams of ester based quaternary ammonium salt is then added to the emulsion along with stirring.

In a fifth embodiment, a method of formulating an encapsulated insect repellent nanoparticle spray-type additive comprises mixing 0.50 grams of 1.00% permethrin with 2.00 grams of TO5. 40.00 grams of ethanol is added to the mixture, followed by the addition of 40.00 grams of PEG200. 2.50 grams of plant extract is added. 15.00 grams of deionized water is added to the mixture along with stirring until the mixture is homogenous.

What is claimed:

1. A method of adding insect repellent to a textile comprising:
providing an insect repelling additive;
immersing a textile in a fluid medium including the insect repelling additive;
disseminating the insect repelling additive throughout the fluid medium;
partially removing the fluid medium from the textile;
drying the textile,
wherein the insect repelling additive is retained by the textile.

2. The method of adding insect repellent to a textile of claim 1, wherein the step of providing the insect repelling additive includes forming the insect repelling additive of 0.10-5.00 ounces of 0.10-5.00% permethrin.

3. The method of adding insect repellent to a textile of claim 1, wherein the step of providing the insect repelling additive includes forming the insect repelling additive of 0.10-5.00 ounces of encapsulated natural extracts.

4. The method of adding insect repellent to a textile of claim 1 further comprising the step of providing a laundry-cleaning apparatus having a rinse cycle.

5. The method of adding insect repellent to a textile of claim 4 further comprising the step of inserting the textile into the laundry-cleaning apparatus.

6. The method of adding insect repellent to a textile of claim 5 further comprising the step of adding the insect repelling additive during the rinse cycle of the laundry-cleaning apparatus.

7. The method of adding insect repellent to a textile of claim 1, wherein the step of immersing the textile includes the fluid medium including a fabric softener.

8. A method of producing an insect repellent composition, comprising steps:
(a) adding substantially 0.05× of benzisothiazolinone to substantially 45.00× of polyethylene glycol (PEG) 200 with stirring;
(b) adding substantially 20.00× of PEG400 and substantially 5.00× of PEG600 with stirring;
(c) adding substantially 20.00× of permethrin;
(d) adding substantially 10.00× of TO5, and
wherein X is a unit of weight and steps (a), (b), (c) and (d) are combined to form a homogeneous mixture.

9. The method of producing an insect repellent composition of claim 8 further comprising the step of adding a fatty acid amide derivative dissolved in deionized water with stirring.

10. The method of producing an insect repellent composition of claim 8 further comprising the step of blending the composition for topical use.

11. The method of producing an insect repellent composition of claim 8 further comprising the step of blending the composition for use in a laundry-cleaning apparatus.

12. The method of claim 8 wherein at least one of steps (a), (b), (c) and (d) are accomplished with stirring

13. A method of repelling insects comprising:
providing an insect repelling additive formed of substantially 0.50× of permethrin, 2.00× of TO5, 40.00× of ethanol, 40.00× of PEG200, 2.50× of plant extracts, 15.00× of deionized water;
applying the additive to an object or a person, and
wherein X is a unit of weight.

14. The method of repelling insects of claim 13, wherein the step of applying the additive includes spraying the additive onto a textile.

15. The method of repelling insects of claim 13, wherein the step of applying the additive includes applying the additive topically as a lotion.
